(19) United States
(12) Patent Application Publication
(10) Pub. No.: US 2021/0279379 A1
(43) Pub. Date: Sep. 9, 2021

(54) PARAMETER EXTRACTION METHOD FOR QUASI-PHYSICAL LARGE-SIGNAL MODEL FOR MICROWAVE GALLIUM NITRIDE HIGH-ELECTRON-MOBILITY TRANSISTORS

(71) Applicant: University of Electronic Science and Technology of China, Chengdu (CN)

(72) Inventors: Yuehang XU, Chengdu (CN); Shuman MAO, Chengdu (CN); Yunqiu WU, Chengdu (CN); Ruimin XU, Chengdu (CN); Bo YAN, Chengdu (CN)

(21) Appl. No.: 17/029,087

(22) Filed: Sep. 23, 2020

(30) Foreign Application Priority Data
Mar. 6, 2020 (CN) 202010154839.6

(51) Int. Cl. G06F 30/20

(52) U.S. Cl. CPC G06F 30/20; G06F 2111/10

(57) ABSTRACT

A parameter extraction method for quasi-physical large-signal model for microwave gallium nitride high-electron-mobility transistors (GaN HEMTs). The method includes: 1) acquiring a data set of parameters for a large-signal model for a plurality of different microwave transistors GaN HEMTs having the same size; 2) performing statistical analysis of physical parameters of the large-signal model and sub-models thereof: 3) characterizing the correlation between the physical parameters by factor analysis; and 4) predicting the output characteristics of the GaN HEMTs.

### CROSS-REFERENCE TO RELATED APPLICATIONS

Pursuant to 35 U.S.C. § 119 and the Paris Convention Treaty, this application claims foreign priority to Chinese Patent Application No. 202010154839.6 filed Mar. 6, 2020, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to a parameter extraction method for quasi-physical large-signal model for microwave gallium nitride high-electron-mobility transistors (GaN HEMTs).

In the fabrication process of semiconductor devices, limited by the epitaxial growth, polarization, and unintentional doping of the semiconductor material, the process parameters tend to fluctuate, thus destroying the consistency of different batches or even the same batch of semiconductor devices, and adversely affecting the quality of the chip circuit. The statistical models of process parameters represent a mapping relationship between the process fluctuation and the output characteristic fluctuation of semiconductor devices, and can be used to assist the optimization and improvement of process parameters, guide the optimization design of chip circuits, effectively reduce the number of optimization iterations, and reduce the design cycle and cost.

Convectional statistical models of process parameters include technology computer aided design (TCAD)-based physical statistical models and empirical statistical models based on compact model theory. It is time-consuming for the TCAD-based physical statistical models to solve the semiconductor equation analytically, which can only meet the needs of the fluctuation of a single physical parameter, so it is difficult to apply to the simultaneous fluctuation of multiple physical parameters. The model equation of the empirical statistical models is derived from a pure mathematical formula and has no physical significance, so it cannot be used in the optimization design of process parameters and chip circuits of semiconductor devices.

### SUMMARY

The disclosure provides a parameter extraction method for quasi-physical large-signal model for microwave gallium nitride high-electron-mobility transistors (GaN HEMTs). The method comprises: 1) acquiring a data set of parameters for a large-signal model for a plurality of different microwave transistors GaN HEMTs having the same size; 2) performing statistical analysis of physical parameters of the large-signal model and sub-models thereof; 3) characterizing the correlation between the physical parameters by factor analysis; and 4) predicting the output characteristics of the GaN HEMTs.

Specifically, the parameter extraction method for quasi-physical large-signal model for microwave GaN HEMTs comprises:

1) DC-IV Measurement of Multiple Batches of Microwave GaN HEMTs:

selecting multiple batches of microwave gallium nitride high-electron-mobility transistors (GaN HEMTs) intended to build a statistical model; measuring static DC-IV characteristics of each of the microwave GaN HEMTs at room temperature, thereby acquiring drain-source currents I_{ds} at different drain-source voltages V_{ds} and different gate-source voltages V_{gs}, where the gate-source voltages V_{gs} range from a pinch-off voltage thereof to 0 V, and the drain-source voltages V_{ds} range from 0 V to a maximum usable drain voltage of each microwave GaN HEMT, which is equal to 50% of a breakdown voltage thereof; the static DC-IV characteristics is measured by Power Device Analyzer/Curve Tracer;

2) Acquiring a Data Set of Parameters for the Statistical Model:

The statistical model to be built is a microwave GaN HEMT quasi-physical large-signal model satisfied with the following formula:

$$\begin{matrix}{I}_{ds} = \frac{{I}_{max} {V}_{ds} ( 1 + λ {V}_{ds} )}{\sqrt[β]{{{E}_{c}^{β} ( {l}_{s} + {l}_{d} )}^{β} + {( {E}_{c} {l}_{g} + {V}_{ds} )}^{β}}} ; & ( 1 ) \\ {n}_{s} = 0.5 {n}_{smax} \cdot tanh ( {α}_{3} \cdot {( {V}_{gs} - {V}_{off} )}^{3} + {α}_{2} \cdot {( {V}_{gs} - {V}_{off} )}^{2} + {α}_{1} \cdot ( {V}_{gs} - {V}_{off} ) + {β}_{n} ) + 0.5 {n}_{smax} ; & ( 2 )\end{matrix}$$

where Iₘₐₓ refers to the maximum drain-source current I_{ds} at different drain-source voltages V_{ds} and at different gate-source voltages V_{gs} and is measured by Power Device Analyzer/Curve Tracer; λ is the channel length modulation coefficient; β is the order of field-velocity relationship; E_{c} is the critical electric field strength; lₛ and l_{d} refer to the lengths of the source and drain access regions, respectively; lₛ is the gate length; nₛ is the electron concentration: nₛₘₐₓ is the maximum electron areal density; V_{off} is the pinch-off voltage; and α₁, α₂, α₃, and βₙ refer to the fitting parameters; lₛ, l_{d} and l_{g} are measured by the SEM photograph of a certain GaN HEMT; V_{off} is regarded as the gate-source voltage V_{gs} when the corresponding lₘₐₓ in the Iₘₐₓ−V_{gs} curve mentioned above is lower than 1 mA.

Formulas (1) and (2) are used to acquire a complete set of model parameters of each microwave GaN HEMT, as well as a maximum electron-saturation velocity vₘₐₓ, a barrier layer thickness d, and fitting parameters a₀, a₁, b₀, b₁, and b₂ for a model for the critical electric field strength E_{c}: the maximum electron velocity vₘₐₓ can be extracted by fitting the slope of the Iₘₐₓ−V_{gs} curve using the least square method: the barrier layer thickness d is extracted by the following formulas:

$$\begin{matrix}d = \frac{{ɛ}_{AlGaN}}{q σ} ( {φ}_{B} - Δ E - {V}_{off} ) ; & ( 3 ) \\ {ɛ}_{AlGaN} = ( 10.4 - 0.3 x ) {ɛ}_{0} ; & ( 4 ) \\ {φ}_{B} = 1.3 x + 0.84 ; & ( 5 ) \\ {E}_{g} = 6.13 x + 3.42 ( 1 - x ) - x ( 1 - x ) ; & ( 6 ) \\ Δ E = 0.7 ( {E}_{g} - 3.42 ) ; & ( 7 )\end{matrix}$$

where x refers to the aluminum mole fraction of the AlGaN/GaN HEMT; co is the permittivity of vacuum;

the extraction process is repeated same number of times for each microwave GaN HEMT, thereby acquiring a complete data set of the model parameters of the multiple batches of microwave GaN HEMTs: the mean value μᵢ and standard deviation Qᵢ of each model parameter in the data set are both calculated, where i represents the i-th microwave GaN HEMT: the calculation method of mean and variance of each parameter are shown in the following formulas:

$$\begin{matrix}d = \frac{{ɛ}_{AlGaN}}{q σ} ( {φ}_{B} - Δ E - {V}_{off} ) ; & ( 8 ) \\ {Q}_{i} = \sqrt{\frac{{\sum }_{k = 1}^{N} {( {X}_{ik} - {μ}_{i} )}^{2}}{N}} ; & ( 9 )\end{matrix}$$

where μᵢ refers to the mean value of the i-th model parameter, Qᵢ refers to the standard deviation of the i-th model parameter, N represents the sample number, k is the i-th model parameter of the k-th sample.

3) Factor Analysis:

3.1) Standardization of Model Parameters:

The model parameters in the data set are arranged in a matrix form such that the data set containing k model parameters is arranged in a matrix with k columns, and each model parameter contains n observations (i.e., n microwave GaN HEMT) corresponding to n rows of the matrix; that is, the matrix has a dimension of n×k:

$$x = [ \begin{matrix}{x}_{11} & {x}_{12} & … & {x}_{1 k} \\ {x}_{21} & {x}_{22} & … & {x}_{2 k} \\ ⋮ & ⋮ & ⋮ & ⋮ \\ {x}_{n 1} & {x}_{n 2} & … & {x}_{nk}\end{matrix} ] ; \qquad ( 10 )$$

The matrix is transformed into a standard matrix X:

$$\begin{matrix}X = [ \begin{matrix}{X}_{11} & {X}_{12} & … & {X}_{1 k} \\ {X}_{21} & {X}_{22} & … & {X}_{2 k} \\ ⋮ & ⋮ & ⋮ & ⋮ \\ {X}_{n 1} & {X}_{n 2} & … & {X}_{nk}\end{matrix} ] ; & ( 11 ) \\ {X}_{ij} = \frac{{x}_{ij} - {\overline{x}}_{j}}{{s}_{j}} , i = 1 , 2 , … , n ; j = 1 , 2 , … , k ; & ( 12 )\end{matrix}$$

where xᵢⱼ represents the i-th observation of the j-th model parameter: x̅ⱼ is the mean value of the j-th model parameter; sⱼ is the standard deviation of the j-th model parameter;

3.2) Calculating Correlation Coefficient Matrix and Eigenvalues Thereof of the Standard Matrix X:

The standard matrix X is used in combination with Formula (13) to calculate each element of a correlation coefficient matrix.

$${r}_{ij} = \frac{{\sum }_{k = 1}^{n} ( {x}_{ki} - {\overline{x}}_{i} ) ( {x}_{kj} - {\overline{x}}_{j} )}{\sqrt{{\sum }_{k = 1}^{n} {( {x}_{ki} - {\overline{x}}_{i} )}^{2} {\sum }_{k = 1}^{n} {( {x}_{kj} - {\overline{x}}_{j} )}^{2}}} i , j = 1 , 2 , … , k ; \qquad ( 13 )$$

The correlation coefficient matrix is used to calculate the eigenvalues λᵢ, and the eigenvalues are sorted from largest to smallest, where i=1, 2, . . . , k;

3.3) Determination of the Number of Principle Components

The eigenvalues calculated in 3.2) are used to calculate the contribution rate and cumulative contribution rate of each principle component Fᵢ, where the contribution rate refers to the percentage of an eigenvalue λᵢ in all of the eigenvalues, and the eigenvalue λᵢ corresponds to the principle component Fᵢ.

$$Contribution rate of principle component {F}_{i} = \frac{{λ}_{i}}{{\sum }_{j = 1}^{k} {λ}_{j}} ; \qquad ( 14 )$$

The larger contribution rate of the principle component Fi, the more the information related to the original data set in the principle component Fi; the cumulative contribution rate of the principle component Fi, represents the sum of the contribution rates of the top i-th principle components, and is satisfied with the following formula:

$$Cumulative contribution rate of principle component {F}_{i} = {\sum }_{p = 1}^{i} \frac{{λ}_{p}}{{\sum }_{j = 1}^{k} {λ}_{j}} ; \qquad ( 15 )$$

Top p principle components having the maximum cumulative contribution rate, or top p principle components having the eigenvalues greater than or equal to 1 are selected.

3.4) Calculating Load Factor and Variance of Specific Factor:

The eigenvectors l₁, l₂, . . . , lₖ are calculated for the corresponding eigenvalues obtained in 3.2). The k eigenvectors are normalized to obtain a combination W of columns of the normalized eigenvectors, that is, W=(W₁, W₂, . . . , Wₖ). The formula A=WΛ is used to calculate the factor loading matrix, where Λ is the diagonal matrix. The factor rotations are performed when the load factors are basically distributed around an average value. And the factor loading matrix of the top p principle components is calculated.

Formula (16) is used to calculate the specific variance:

$${σ}_{i}^{2} = 1 - {\sum }_{{ }^{j = 1}}^{3} {L}_{ij}^{2} ; \qquad ( 16 )$$

where σᵢ is the standard deviation of the specific factors of the i-th model parameter; and Lᵢⱼ is the load factor of the j-th principle component.

4) Statistical Characterization of Model Parameters:

According to the factor analysis theory, the common factors and the specific factors are used to predict each corresponding model parameter, and the following formula is satisfied:

$${X}_{i} = {μ}_{i} + {Q}_{i} ( {{\sum }^{3}}_{j = 1} {L}_{ij} {F}_{j} + {ɛ}_{i} ) ; \qquad ( 17 )$$

where Xᵢ is a parameter of the model I_{d}; μᵢ and Qᵢ refer to the mean value and the standard deviation of the actually extracted model parameter Xᵢ; Lᵢⱼ is the load factor of the j-th principle components of the model parameter Xᵢ; εᵢ is the specific factor of the model parameter Xᵢ, and obeys a normal distribution with zero mean: the common factors are independent of each other, with zero mean and a variance of 1;

5) Quasi-Physical Large-Signal Model:

The statistical distribution characteristics of each model parameter in 4) are substituted into a conventional large-signal model called Quasi-physical Zone Division model to obtain a complete quasi-physical statistical model for a device. The nonlinear harmonic balance method is used to solve the quasi-physical statistical model, thereby obtaining the large-signal output characteristics of the device.

Further, in 3.2), a method for calculating the eigenvectors λᵢ is to solve |R−λEₖ|=0 for the correlation coefficient matrix R, where i=1, 2, 3, . . . , k; and

E is the k-th order identity matrix;

$${E}_{k} = [ \begin{matrix}1 & 0 & ⋯ & 0 \\ 0 & 1 & ⋯ & 0 \\ ⋮ & ⋮ & ⋱ & ⋮ \\ 0 & 0 & ⋯ & 1\end{matrix} ] ;$$

For |R−λEₖ|=0, the expanded form of the determinant is as follows:

$$\vert R - λ {E}_{k} \vert = \vert \begin{matrix}{r}_{11} - {λ}_{1} & {r}_{12} & ⋯ & {r}_{1 k} \\ {r}_{21} & {r}_{22} - {λ}_{2} & ⋯ & {r}_{2 k} \\ ⋮ & ⋮ & ⋱ & ⋮ \\ {r}_{k 1} & {r}_{k 2} & ⋯ & {r}_{kk} - {λ}_{k}\end{matrix} \vert = 0.$$

The following advantages are associated with the disclosure: the parameter extraction method for quasi-physical large-signal model for microwave GaN HEMTs lays a foundation for optimization of the process parameters and product yield of semiconductor devices.

### BRIEF DESCRIPTION OF THE DRAWINGS

FIG. 1 is a flowchart of a parameter extraction method for quasi-physical large-signal model for microwave GaN HEMTs;

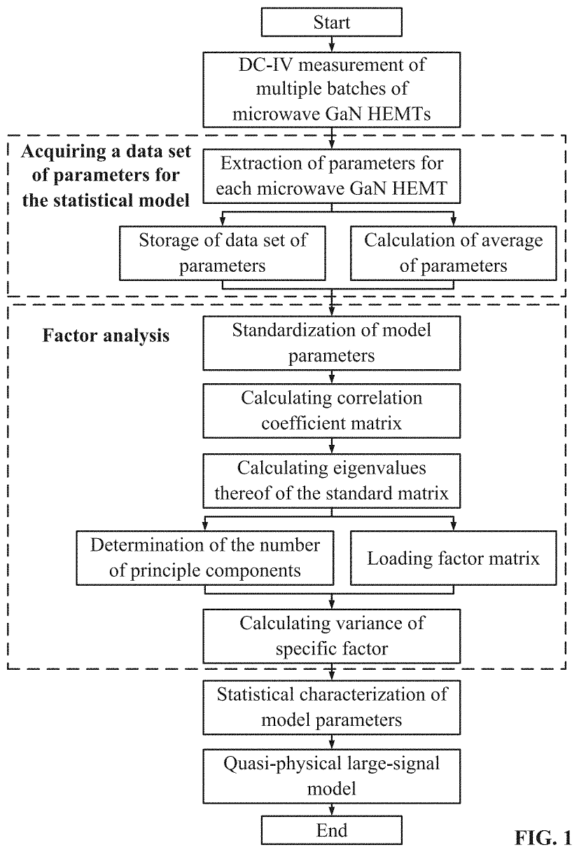

FIG. 2 shows the drain-source current Ids observed at different drain-source voltage Vds and different gate-source voltage Vgs;

FIG. 3 shows the transconductance gₘ observed at different gate-source voltage Vgs and at a constant drain-source voltage Vds; and

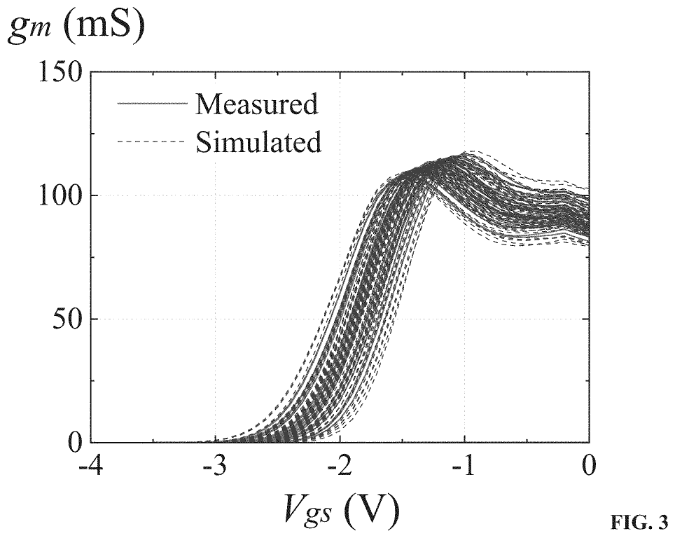

FIG. 4 shows a comparison of the RF output characteristic of the device at different power under different external conditions.

### DETAILED DESCRIPTION

To further illustrate the disclosure, embodiments detailing a parameter extraction method for quasi-physical large-signal model for microwave gallium nitride (GaN) high-electron-mobility transistors (HEMTs) are described below. It should be noted that the following embodiments are intended to describe and not to limit the disclosure.

Provided is a parameter extraction method for quasi-physical large-signal model for microwave gallium nitride high-electron-mobility transistors (GaN HEMTs), the method comprising:

1) DC-IV Measurement of Multiple Batches of Microwave GaN HEMTs:

Multiple batches of microwave GaN HEMTs are selected to build a statistical model; static DC-IV characteristics of each of the microwave GaN HEMTs are measured at room temperature; and the drain-source current I_{ds} at different drain-source voltages V_{ds} and different gate-source voltages V_{gs} is observed, where the gate-source voltage V_{gs} is scanned from pinch-off voltage to 0 V, and the drain-source voltage is scanned from 0 V to the maximum usable drain voltage (i.e. 50% breakdown voltage). The static DC-IV characteristics is measured by Power Device Analyzer/Curve Tracer.

2) Acquiring a Data Set of Parameters for the Statistical Model:

The statistical model to be built, is a microwave GaN HEMT quasi-physical large-signal model satisfied with the following formula

$${I}_{ds} = \frac{{I}_{max} {V}_{ds} ( 1 + λ {V}_{ds} )}{\sqrt[β]{{{E}_{c}^{β} ( {l}_{s} + {l}_{d} )}^{β} + {( {E}_{c} {l}_{g} + {V}_{ds} )}^{β}}} ; \qquad ( 1 )$$

where Iₘₐₓ refers to the maximum drain-source current I_{ds} at different drain-source voltages V_{ds} and gate-source voltages V_{gs} and is measured by Power Device Analyzer/Curve Tracer; λ is the channel length modulation coefficient; β is the order of field-velocity relationship; E_{c} is the critical electric field strength; lₛ and l_{d} refer to the lengths of the source and drain access regions, respectively: l_{g} is the gate length; lₛ, l_{d} and l_{g} are measured by the SEM photograph of a certain GaN HEMT; V_{off} is regarded as the gate-source voltage V_{gs} when the corresponding lₘₐₓ in the Iₘₐₓ−V_{gs} curve mentioned above is lower than 1 mA; while for other model parameters above, they are all extracted using a Chinese patent titled “A method and system for parameter extraction of microwave GaN device nonlinear current model” (The application number is CN201810096978.0).

To accurately fit the I-V curves of all of devices, nₛ(V_{gs}) is optimized as follows:

$${n}_{s} = 0.5 {n}_{smax} \cdot tanh ( {α}_{3} \cdot {( {V}_{gs} - {V}_{off} )}^{3} + {α}_{2} \cdot {( {V}_{gs} - {I}_{off} )}^{2} + {α}_{1} \cdot ( {V}_{gs} - {V}_{off} ) + {β}_{n} ) + 0.5 {n}_{smax} ; \qquad ( 2 )$$

where, nₛ is the electron concentration; nₛₘₐₓ is the maximum electron areal density; V_{off} is the pinch-off voltage; and α₁, α₂, α₃, and, βₙ refer to the fitting parameters; V_{off} is regarded as the gate-source voltage V_{gs} when the corresponding Iₘₐₓ in the Iₘₐₓ−V_{gs} curve mentioned above is lower than 1 mA; While for other model parameters above, they are all extracted using Iₘₐₓ data mentioned above based on the method in a Chinese patent titled “A method and system for parameter extraction of microwave GaN device nonlinear current model” (The application number is CN201810096978.0).

Formula (1) and (2) are used to acquire a complete set of model parameters of each microwave GaN HEMT, as well as a maximum electron-saturation velocity vₘₐₓ, a barrier layer thickness d, and fitting parameters a₀, a₁, b₀, b₁, and b₂ for a model for the critical electric field strength Ec; The maximum electron velocity vₘₐₓ can be extracted by fitting the slope of the Iₘₐₓ−V_{gs} curve using the least square method; the barrier layer thickness d can be extracted by the following formulas; While for model parameters in critical electric field E_{c} model, they are all extracted using the drain-source current I_{ds} measured also by Power Device Analyzer/Curve Tracer (Keysight B1505A) based on the method in a Chinese patent titled “A method and system for parameter extraction of microwave GaN device nonlinear current model” (The application number is CN201810096978.0):

$$\begin{matrix}d = \frac{{ɛ}_{AlGaN}}{q σ} ( {φ}_{B} - Δ E - {V}_{off} ) ; & ( 3 ) \\ {ɛ}_{AlGaN} = ( 10.4 - 0.3 x ) {ɛ}_{0} ; & ( 4 ) \\ {φ}_{B} = 1.3 x + 0.84 ; & ( 5 ) \\ {E}_{g} = 6.13 x + 3.42 ( 1 - x ) - x ( 1 - x ) ; & ( 6 ) \\ Δ E = 0.7 ( {E}_{g} - 3.42 ) ; & ( 7 )\end{matrix}$$

where x refers to the aluminum mole fraction of the AlGaN/GaN HEMT: ε₀ is the permittivity of vacuum.

The extraction process is repeated same number of times for each microwave GaN HEMT, thereby acquiring a complete data set of the model parameters of the multiple batches of microwave GaN HEMTs; The mean value μᵢ and standard deviation Qᵢ of each model parameter in the data set are both calculated, as shown in Table 1, where i represents the i-th microwave GaN HEMT. The calculation method of mean and variance of each parameter are shown in the following formulas:

$$\begin{matrix}d = \frac{{ɛ}_{AlGaN}}{q σ} ( {φ}_{B} - Δ E - {V}_{off} ) ; & ( 8 ) \\ {Q}_{i} = \sqrt{\frac{{\sum }_{k = 1}^{N} {( {X}_{ik} - {μ}_{i} )}^{2}}{N}} ; & ( 9 )\end{matrix}$$

where μᵢ refers to the mean value of the i-th model parameter, Qᵢ refers to the standard deviation of the i-th model parameter, N represents the sample number, k is the i-th model parameter of the k-th sample.

TABLE 1
Mean and standard deviation of each model
parameter extracted from measured data

| | | |
|---|---|---|
| Parameter | Mean | Standard |

| | | | | |
|---|---|---|---|---|
| d | 18.74 | nm | 0.60 | nm |
| vₘₐₓ | 1.53 × 10⁵ | m/s | 0.03 × 10⁵ | m/s |
| nₛₘₐₓ | 8.42 × 10¹⁶ | m⁻² | 2.96 × 10¹⁵ | m⁻² |

| | | |
|---|---|---|
| α₁ | 2.32 | 0.13 |
| α₂ | −1.20 | 0.12 |
| α₃ | 0.31 | 0.04 |
| βₙ | −1.59 | 0.02 |
| a₀ | 1208.13 | 124.72 |
| a₁ | −788.87 | 123.24 |
| b₀ | 1418.85 | 46.89 |
| b₁ | −64.08 | 2.22 |
| b₂ | 0.75 | 0.03 |

3) Factor Analysis:

3.1) Standardization of Model Parameters:

The model parameters in the data set are arranged in matrix form such that the data set containing k model parameters is arranged in a matrix with k columns, and each model parameter contains n observations (i.e., n microwave GaN HEMT) corresponding to n rows of the matrix: that is, the matrix is a n×k matrix:

$$x = [ \begin{matrix}{x}_{11} & {x}_{12} & ⋯ & {x}_{1 k} \\ {x}_{21} & {x}_{22} & ⋯ & {x}_{2 k} \\ ⋮ & ⋮ & ⋱ & ⋮ \\ {x}_{n 1} & {x}_{n 2} & … & {x}_{nk}\end{matrix} ] . \qquad ( 10 )$$

The above matrix is transformed into a standard matrix X:

$$\begin{matrix}X = [ \begin{matrix}{X}_{11} & {X}_{12} & ⋯ & {X}_{1 k} \\ {X}_{21} & {X}_{22} & ⋯ & {X}_{2 k} \\ ⋮ & ⋮ & ⋮ & ⋮ \\ {X}_{n 1} & {X}_{n 2} & … & {X}_{nk}\end{matrix} ] ; & ( 11 ) \\ {X}_{ij} = \frac{{x}_{ij} - {\overline{x}}_{j}}{{s}_{j}} , i = 1 , 2 , ⋯ , n ; j = 1 , 2 , ⋯ , k ; & ( 12 )\end{matrix}$$

where xᵢⱼ represents the i-th observation of the j-th model parameter; x̅ⱼ is the mean value of the j-th model parameter; sⱼ is the standard deviation of the j-th model parameter, as shown in Table 1.

3.2) Calculating correlation coefficient matrix and eigenvalues thereof of the matrix X:

The matrix X is used in combination with Formula (13) to calculate each element of a correlation coefficient matrix, and the results are shown in Table 2:

$${r}_{ij} = \frac{{\sum }_{k = 1}^{n} ( {x}_{ki} - {\overline{x}}_{i} ) ( {x}_{kj} - {\overline{x}}_{j} )}{\sqrt{{\sum }_{k = 1}^{n} {( {x}_{ki} - {\overline{x}}_{i} )}^{2} {\sum }_{k = 1}^{n} {( {x}_{kj} - {\overline{x}}_{j} )}^{2}}} i , j = 1 , 2 , ⋯ , k ; \qquad ( 13 )$$

TABLE 2
Correlation coefficient matrix of each model parameter

| Original | | | | | | | | | | | | |
|---|---|---|---|---|---|---|---|---|---|---|---|---|
| variable | d | vₘₐₓ | nₛₘₐₓ | α₁ | α₂ | α₃ | βₙ | a₀ | a₁ | b₀ | b₁ | b₂ |
| d | 1 | | | | | | | | | | | |
| vₘₐₓ | −0.66 | 1 | | | | | | | | | | |
| nₛₘₐₓ | 0.98 | −0.61 | 1 | | | | | | | | | |
| α₁ | −0.72 | 0.09 | −0.79 | 1 | | | | | | | | |
| α₂ | 0.77 | −0.18 | 0.84 | −0.99 | 1 | | | | | | | |
| α₃ | −0.89 | 0.38 | −0.94 | 0.94 | −0.97 | 1 | | | | | | |
| βₙ | −0.06 | 0.57 | 0.03 | −0.61 | 0.53 | −0.33 | 1 | | | | | |
| a₀ | 0.18 | −0.74 | 0.13 | 0.41 | −0.33 | 0.13 | −0.82 | 1 | | | | |
| a₁ | 0.02 | −0.50 | −0.01 | 0.51 | −0.44 | 0.27 | −0.83 | 0.85 | 1 | | | |
| b₀ | 0.21 | −0.09 | 0.24 | −0.32 | 0.33 | −0.33 | 0.24 | −0.22 | −0.09 | 1 | | |
| b₁ | 0.16 | 0.25 | 0.16 | −0.31 | 0.28 | −0.21 | 0.24 | −0.28 | −0.41 | −0.72 | 1 | |
| b₂ | −0.41 | −0.20 | −0.44 | 0.66 | −0.64 | 0.56 | −0.43 | 0.43 | 0.55 | 0.35 | −0.89 | 1 |

The correlation coefficient matrix is used to calculate the eigenvalues λᵢ, and the eigenvalues are then sorted from largest to smallest, where i=1, 2, . . . , k;

Specifically, a method for calculating the eigenvectors λᵢ is to solve |R−λEₖ|=0 for the correlation coefficient matrix R, where i=1, 2, 3, . . . , k; and E is the k-th order identity matrix;

$${E}_{k} = [ \begin{matrix}1 & 0 & ⋯ & 0 \\ 0 & 1 & ⋯ & 0 \\ ⋮ & ⋮ & ⋱ & ⋮ \\ 0 & 0 & ⋯ & 1\end{matrix} ] .$$

For |R−λEₖ|=0, the expanded form of the determinant is as follows:

$$\vert R - λ {E}_{k} \vert = \vert \begin{matrix}{r}_{11} - {λ}_{1} & {r}_{12} & ⋯ & {r}_{1 k} \\ {r}_{21} & {r}_{22} - {λ}_{2} & ⋯ & {r}_{2 k} \\ ⋮ & ⋮ & ⋱ & ⋮ \\ {r}_{k 1} & {r}_{k 2} & ⋯ & {r}_{kk} - {λ}_{k}\end{matrix} \vert = 0.$$

3.3) Determination of the Number of Principle Components

The eigenvalues calculated in 3.2) are used to calculate the contribution rate and cumulative contribution rate of each principle component Fᵢ, where the contribution rate refers to the percentage of an eigenvalue λᵢ in all of the eigenvalues, and the eigenvalue λᵢ corresponds to the principle component Fᵢ.

$$Contribution rate of principle component {F}_{i} = \frac{{λ}_{i}}{{\sum }_{j = 1}^{k} {λ}_{j}} . \qquad ( 14 )$$

The larger the contribution rate of the principle component Fᵢ, the more the information related to the original data set in the principle component Fᵢ; the cumulative contribution rate of the principle component Fᵢ represents the sum of the contribution rates of the top i-th principle components, and is satisfied with the following formula:

$$Cumulative contribution rate of principle component {F}_{i} = {\sum }_{p = 1}^{i} \frac{{λ}_{p}}{{\sum }_{j = 1}^{k} {λ}_{j}} . \qquad ( 15 )$$

The contribution rate and cumulate contribution rate of each principle component are calculated as shown in Table 3.

TABLE 3
Contribution rate of each principle component
and cumulate contribution rates

| | Principle component | | | | | |
|---|---|---|---|---|---|---|
| | F₁ | F₂ | F₃ | F₄ | . . . | F₁₂ |
| Contribution | 47.03 | 30.49 | 17.22 | 2.34 | . . . | 3.68 × 10⁻⁴ |
| rate (%) | | | | | | |
| Cumulate | 47.03 | 77.52 | 94.74 | 97.08 | . . . | 100 |
| contribution | | | | | | |
| rate (%) | | | | | | |

The top p principle components are selected so that the cumulate contribution rate is above 85% or the eigenvalue is greater than or equal to 1; referring to Table 3, the top 3 principle components of the data set of the I_{ds} model parameter has a variance of 94.74%, illustrating that the data set can be explained with three variances independent of each other.

3.4) Calculating Load Factor and Variance of Specific Factor:

The eigenvectors l₁, l₂, . . . , lₖ are calculated for the corresponding eigenvalues obtained in 3.2). The k eigenvectors are normalized to obtain a combination W of columns of the normalized eigenvectors, that is, W=(W₁, W₂, . . . , Wₖ). The formula A=WΛ is used to calculate the factor loading matrix, where Λ is the diagonal matrix. It is necessary to perform factor rotations when the load factors are basically distributed around an average value. And the factor loading matrix of the top p principle components is calculated. The number of the principle components determined in 3) is 3, which are used to calculate the loading factor matrix as shown in Table 4.

TABLE 4
Factor loading matrix

| | F₁ | F₂ | F₃ |
|---|---|---|---|
| d | 0.9515 | 0.2730 | −0.0662 |
| vₘₐₓ | −0.4960 | −0.7442 | −0.1602 |
| nₛₘₐₓ | 0.9812 | 0.1770 | −0.0359 |
| α₁ | −0.8864 | 0.4576 | 0.0358 |
| α₂ | 0.9257 | −0.3722 | −0.0221 |
| α₃ | −0.9872 | 0.1482 | 0.0020 |
| βₙ | 0.2054 | −0.9380 | 0.0419 |
| a₀ | −0.0146 | 0.8705 | 0.0613 |
| a₁ | −0.1583 | 0.8079 | 0.1835 |
| b₀ | 0.3163 | −0.1749 | 0.8688 |
| b₁ | 0.1803 | −0.2596 | −0.9463 |
| b₂ | −0.5037 | 0.4196 | 0.7312 |

Since only three principle components are used to explain the statistical distribution and leads to severe information loss, the specific factors are introduced for a minimum information loss.

Formula (16) is used to calculate the variance of the specific factors:

$${σ}_{i}^{2} = 1 - {\sum }_{j = 1}^{3} {L}_{ij}^{2} ; \qquad ( 16 )$$

where σᵢ is the standard deviation of the specific factor of the i-h model parameter; and Lᵢⱼ is the load factor of the j-th principle component. And the results are shown in Table 5.

TABLE 5
Variance of specific factors of corresponding model parameter

| Original | Variance of |
|---|---|
| variable | specific factors |
| d | 0.0155 |
| vₘₐₓ | 0.1244 |
| nₛₘₐₓ | 0.0052 |
| α₁ | 0.0550 |
| α₂ | 0.0143 |
| α₃ | 0.0872 |
| βₙ | 0.0760 |
| a₀ | 0.0382 |
| a₁ | 0.0883 |
| b₀ | 0.1144 |
| b₁ | 0.0050 |
| b₂ | 0.0353 |

4) Statistical Characterization of Model Parameters:

According to the factor analysis theory, the common factors and the specific factors are used to predict each corresponding model parameter, and the following formula is satisfied:

$${X}_{i} = {μ}_{i} + {Q}_{i} ( {\sum }_{j = 1}^{3} {L}_{ij} {F}_{j} + {ɛ}_{i} ) ; \qquad ( 17 )$$

where Xᵢ is a parameter of the model Iₛₛ; μᵢ and Qᵢ refer to the mean value and the standard deviation of the actually extracted model parameter Xᵢ; Lᵢⱼ is the load factor of the jₜₕ principle components of the model parameter Xᵢ; εᵢ is the specific factor of the model parameter Xᵢ, and obeys a normal distribution with zero mean. The common factors are independent of each other, with a zero mean and a variance of 1.

The mean value μᵢ and standard deviation σᵢ of model parameters in Table 1, the factor loading matrix Lᵢⱼ in Table 4, the variance e, of each model parameter in Table 5, and the random numbers from the standard normal distribution N(0, 1) are substituted into Formula (17), thereby obtaining statistical characteristics for characterizing the model parameters.

5) Quasi-Physical Large-Signal Model:

The statistical distribution characteristics of each model parameter in 4) are substituted into a conventional large-signal model called Quasi-physical Zone Division model (Reported in Z. Wen, Y. Xu, Y. Chen, H. Tao, C. Ren, H. Lu, Z. Wang, W. Zheng, B. Zhang, T. Chen, T. Gao and R. Xu, “A Quasi-Physical Compact Large-Signal Model for AlGaN/GaN HEMTs,” IEEE Transactions on Microwave Theory and Techniques, vol. 65, no. 12, pp. 5113-5122, December 2017.) to obtain a complete quasi-physical statistical model for a device. The nonlinear harmonic balance method is used to solve the quasi-physical statistical model, thereby obtaining the large-signal output characteristics of the device.

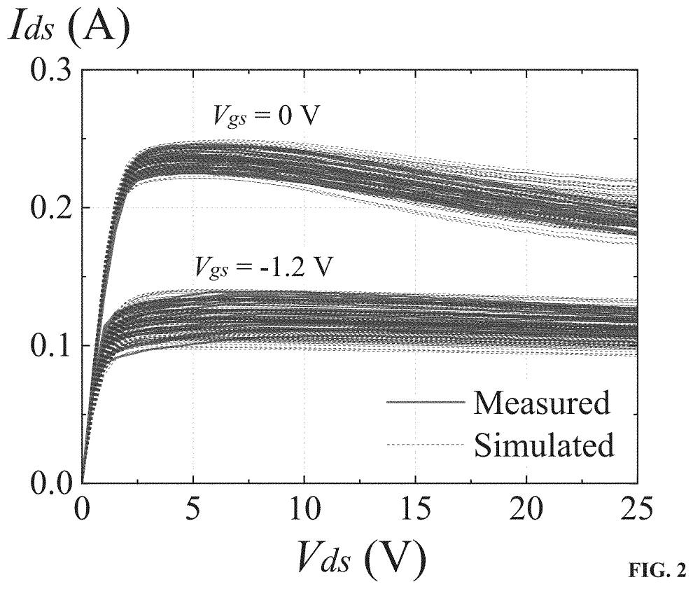

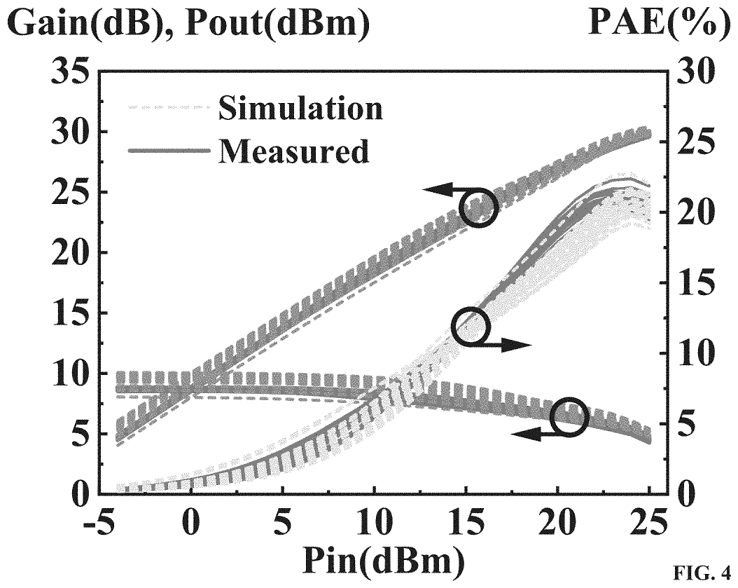

In the embodiment of the disclosure, the output characteristic of the device includes DC characteristic and RF output characteristic. Referring to FIG. 2, the DC characteristic is determined by the drain-source current I_{ds} at one or two gate-source voltage V_{gs} and different drain-source V_{gs}, and the transconductance g, at different gate-source voltage V_{gs} and at a constant drain-source voltage V_{ds}. The RF output characteristic is determined by output power (Pout), gain (Gain), and power-added efficiency (PAE) at different input power when the device has constant input impedance and output impedance, and is operated at a specific frequency and in fixed bias point. Referring to FIG. 4, the dotted line represents the results simulated by the model, and the solid line represents the results plotted with measured data.

It will be obvious to those skilled in the art that changes and modifications may be made, and therefore, the aim in the appended claims is to cover all such changes and modifications.

What is claimed is:

1. A method, comprising:
1) selecting multiple batches of microwave gallium nitride high-electron-mobility transistors (GaN HEMTs) intended to build a statistical model: measuring static DC-IV characteristics of each of the microwave GaN HEMTs at room temperature, thereby acquiring drain-source currents I_{ds} at different drain-source voltages V_{ds} and different gate-source voltages V_{gs}, where the gate-source voltages V_{gs} range from a pinch-off voltage thereof to 0 V, and the drain-source voltages V_{ds} range from 0 V to a maximum usable drain voltage of each microwave GaN HEMT, which is equal to 50% of a breakdown voltage thereof;
2) building a microwave GaN HEMT quasi-physical large-signal model satisfying the following formulas:
$$\begin{matrix}{I}_{ds} = \frac{{I}_{max} {V}_{ds} ( 1 + λ {V}_{ds} )}{\sqrt[β]{{{E}_{c}^{β} ( {l}_{s} + {l}_{d} )}^{β} + {( {E}_{c} {l}_{g} + {V}_{ds} )}^{β}}} ; & ( 1 ) \\ {n}_{s} = 0.5 {n}_{smax} \cdot tanh ( {α}_{3} \cdot {( {V}_{gs} - {V}_{off} )}^{3} + {α}_{2} \cdot {( {V}_{gs} - {V}_{off} )}^{2} + {α}_{1} \cdot ( {V}_{gs} - {V}_{off} ) + {β}_{n} ) + 0.5 {n}_{smax} ; & ( 2 )\end{matrix}$$
where Iₘₐₓ refers to a maximum drain-source current I_{ds} at different drain-source voltages V_{ds} and at different gate-source voltages V_{ds}; λ is a channel length modulation coefficient: β is an order of field-velocity relationship: E_{c} is a critical electric field strength: lₛ and l_{d} refer to lengths of a source access region and a drain access region, respectively; l_{g} is a gate length; nₛ is an electron concentration: nₛₘₐₓ is a maximum electron areal density; V_{off} is a pinch-off voltage; and α₁, α₂, α₃, and βₙ refer to fitting parameters; lₛ, l_{d} and l_{g} are measured by the SEM photograph of a certain GaN HEMT; V_{off} is regarded as the gate-source voltage V_{gs} when the corresponding Iₘₐₓ in the Iₘₐₓ−V_{gs} curve mentioned above is lower than 1 mA;
based on formulas (1) and (2), acquiring a complete set of model parameters of each microwave GaN HEMT, a maximum electron-saturation velocity vₘₐₓ, a barrier layer thickness d, and fitting parameters a₀, a₁, b₀, b₁, and b₂ for a model for the critical electric field strength E_{c}; wherein a maximum electron velocity vₘₐₓ is extracted by fitting the slope of the Iₘₐₓ−V_{gs} curve using the least square method; the barrier layer thickness d is extracted by the following formulas:
$$\begin{matrix}d = \frac{{ɛ}_{AlGaN}}{q σ} ( {φ}_{B} - Δ E - {V}_{off} ) ; & ( 3 ) \\ {ɛ}_{AlGaN} = ( 10.4 - 0.3 x ) {ɛ}_{0} ; & ( 4 ) \\ {φ}_{B} = 1.3 x + 0.84 ; & ( 5 ) \\ {E}_{g} = 6.13 x + 3.42 ( 1 - x ) - x ( 1 - x ) ; & ( 6 ) \\ Δ E = 0.7 ( {E}_{g} - 3.42 ) ; & ( 7 )\end{matrix}$$
where x refers to an aluminum mole fraction of the AlGaN/GaN HEMT; co is a permittivity of vacuum;
repeating operations to extract the model parameters of each microwave GaN HEMT, thereby acquiring a complete data set of the model parameters of the multiple batches of microwave GaN HEMTs; calculating a mean value μᵢ and a standard deviation Qᵢ of each model parameter in the data set, where i represents an i-th microwave GaN HEMT: the calculation method of mean and variance of each parameter are shown in the following formulas:
$$\begin{matrix}d = \frac{{ɛ}_{AlGaN}}{q σ} ( {φ}_{B} - Δ E - {V}_{off} ) ; & ( 8 ) \\ {Q}_{i} = \sqrt{\frac{{\sum }_{k = 1}^{N} {( {X}_{ik} - {μ}_{i} )}^{2}}{N}} ; & ( 9 )\end{matrix}$$
where μᵢ refers to the mean value of an i-th model parameter, Qᵢ refers to the standard deviation of the i-th model parameter, N represents a sample number, k is the i-th model parameter of the k-th sample:
3) performing factor analysis, comprising:
3.1) arranging the model parameters in the data set in a matrix form such that the data set containing k model parameters is arranged in a matrix with k columns, and each model parameter contains n observations and n microwave GaN HEMTs, wherein the matrix has a dimension of n×k;
$$x = [ \begin{matrix}{x}_{11} & {x}_{12} & … & {x}_{1 k} \\ {x}_{21} & {x}_{22} & … & {x}_{2 k} \\ ⋮ & ⋮ & ⋮ & ⋮ \\ {x}_{n 1} & {x}_{n 2} & … & {x}_{nk}\end{matrix} ] ; \qquad ( 10 )$$
transforming the matrix into a standard matrix X:
$$\begin{matrix}X = [ \begin{matrix}{X}_{11} & {X}_{12} & … & {X}_{1 k} \\ {X}_{21} & {X}_{22} & … & {X}_{2 k} \\ ⋮ & ⋮ & ⋮ & ⋮ \\ {X}_{n 1} & {X}_{n 2} & … & {X}_{nk}\end{matrix} ] ; & ( 11 ) \\ {X}_{ij} = \frac{{x}_{ij} - {\overline{x}}_{j}}{{s}_{j}} , i = 1 , 2 , … , n ; j = 1 , 2 , … , k ; & ( 12 )\end{matrix}$$
where xᵢⱼ represents an i-th observation of a j-th model parameter; x̅ⱼ is a mean value of the j-th model parameter: sⱼ is a standard deviation of the j-th model parameter;
3.2) calculating, based on the standard matrix X and the following formula (13), each element of a correlation coefficient matrix:
$${r}_{ij} = \frac{{\sum }_{k = 1}^{n} ( {x}_{ki} - {\overline{x}}_{i} ) ( {x}_{kj} - {\overline{x}}_{j} )}{\sqrt{{\sum }_{k = 1}^{n} {( {x}_{ki} - {\overline{x}}_{i} )}^{2} {\sum }_{k = 1}^{n} {( {x}_{kj} - {\overline{x}}_{j} )}^{2}}} i , j = 1 , 2 , … , k ; \qquad ( 13 )$$
based on the correlation coefficient matrix, calculating an eigenvalue λᵢ, and sorting a plurality of eigenvalues from largest to smallest, where i=1, 2, . . . , k;
3.3) calculating, based on the eigenvalues in 3.2), a contribution rate and a cumulative contribution rate of each principle component Fᵢ, where the contribution rate refers to a percentage of an eigenvalue λᵢ in all of the eigenvalues, and the eigenvalue λᵢ corresponds to the principle component Fᵢ;
$$Contribution rate of principle cmponent {F}_{i} = \frac{{λ}_{i}}{{\sum }_{j = 1}^{k} {λ}_{j}} ; \qquad ( 14 )$$
the larger the contribution rate of the principle component Fᵢ, the more the information related to the original data set in the principle component Fᵢ; wherein the cumulative contribution rate of the principle component Fᵢ represents a sum of the contribution rates of top i-th principle components, and is calculated as follows:
$$Cumulative contribution rate of principle component {F}_{i} = {\sum }_{p = 1}^{i} \frac{{λ}_{p}}{{\sum }_{j = 1}^{k} {λ}_{j}} ; \qquad ( 15 )$$
selecting top p principle components having a maximum cumulative contribution rate, or top p principle components having the eigenvalues greater than or equal to 1;
3.4) calculating eigenvectors l₁, l₂, . . . , lₖ the corresponding eigenvalues obtained in 3.2): normalizing the k eigenvectors to obtain a combination W of columns of the normalized eigenvectors, W=(W₁, W₂, . . . , Wₖ); calculating a factor loading matrix using the formula A=WΛ, where Λ is a diagonal matrix; performing factor rotations when the load factors are distributed around an average value; calculating the factor loading matrix of the top p principle components;
calculating a specific variance using the following formula:
$${σ}_{i}^{2} = 1 - {\sum }_{j = 1}^{3} {L}_{ij}^{2} ; \qquad ( 16 )$$
where σᵢ is a standard deviation of specific factors of the i-th model parameter; and Lᵢⱼ is a load factor of the j-th principle component;
4) according to the factor analysis theory, predicting each corresponding model parameter using common factors and the specific factors with the following formula:
$${X}_{i} = {μ}_{i} + {Q}_{i} ( {\sum }_{j = 1}^{3} {L}_{ij} {F}_{j} + {ɛ}_{i} ) ; \qquad ( 17 )$$
where Xᵢ is a parameter of a model I_{ds}; μᵢ and Qᵢ refer to the mean value and the standard deviation of the actually extracted model parameter Xᵢ; Lᵢⱼ is the load factor of the j-th principle components of the model parameter Xᵢ; εᵢ is the specific factor of the model parameter Xᵢ, and obeys a normal distribution with zero mean; the common factors are independent of each other, with zero mean and a variance of 1; and
5) substituting statistical distribution characteristics of each model parameter in 4) to a conventional large-signal model for a semiconductor device to obtain a complete quasi-physical statistical model thereof; solving the quasi-physical statistical model using a nonlinear harmonic balance method, thereby obtaining the large-signal output characteristics of the semiconductor device.

2. The method of claim 1, wherein in 3.2), calculating the eigenvectors λᵢ comprises solving the equation |R−λEₖ|=0, where i=1, 2, 3, . . . , k; and E is a k-th order identity matrix;
$${E}_{k} = [ \begin{matrix}1 & 0 & … & 0 \\ 0 & 1 & … & 0 \\ ⋮ & ⋮ & ⋱ & ⋮ \\ 0 & 0 & … & 1\end{matrix} ] ;$$
for |R−λEₖ|=0, an expanded form of a determinant is as follows:
$$\vert R - λ {E}_{k} \vert = \vert \begin{matrix}{r}_{11} - {λ}_{1} & {r}_{12} & … & {r}_{1 k} \\ {r}_{21} & {r}_{22} - {λ}_{2} & … & {r}_{2 k} \\ ⋮ & ⋮ & ⋱ & ⋮ \\ {r}_{k 1} & {r}_{k 2} & … & {r}_{kk} - {λ}_{k}\end{matrix} \vert = 0.$$
